(19) United States
(12) Patent Application Publication
(10) Pub. No.: US 2013/0284257 A1
(43) Pub. Date: Oct. 31, 2013

(54) MICROLENS ARRAY FOR SOLAR CELLS

(71) Applicants: James Gilchrist, Orefield, PA (US); Mark A. Snyder, Nazareth, PA (US); Pisist Kumnorkaew, Bethlehem, PA (US)

(72) Inventors: James Gilchrist, Orefield, PA (US); Mark A. Snyder, Nazareth, PA (US); Pisist Kumnorkaew, Bethlehem, PA (US)

(73) Assignee: Lehigh University, Bethlehem, PA (US)

(21) Appl. No.: 13/817,616

(22) PCT Filed: Dec. 30, 2010
(86) PCT No.: PCT/US10/62478

§ 371 Date: May 21, 2013

Related U.S. Application Data
(60) Provisional application No. 61/375,072, filed on Aug. 19, 2010.
(60) Provisional application No. 61/417,696, filed on Nov. 29, 2010.

(51) Int. Cl. H01G 9/20

(52) U.S. Cl. CPC H01G 9/209
USPC 136/256; 438/71

(57) ABSTRACT

A dye-sensitized solar cell with internal microlens array includes an anodic electrode, a cathodic counter-electrode, and an electrolyte. The anodic electrode includes a porous nano-structured active metal oxide layer having a sensitizer dye adsorbed thereon. In one embodiment, a microlens array comprising a plurality of microlens elements is disposed between the electrodes, and preferably between a transparent substrate of the anodic electrode and active metal oxide layer for dispersing light incident on the substrate to the active oxide layer. In some embodiments, the microlens elements may be convex or concave in configuration. The microlens array improves solar conversion efficiency of the solar cell. A method for forming a microlens array is further provided.

### CROSS REFERENCE TO RELATED APPLICATIONS

This present application claims the benefit of priority to U.S. Provisional Patent Applications Nos. 61/375,072 filed Aug. 19, 2010 and 61/417,696 filed Nov. 29, 2010; the entire contents of each being incorporated herein by reference in their entireties.

### FIELD OF DISCLOSURE

The present disclosure relates to a solar cells, and more particularly to dye-sensitized solar cells (DSSC).

### BACKGROUND OF THE DISCLOSURE

Solar cells harness a renewable source of energy in the form of light which is converted into useful electrical energy that may be used for numerous applications. One class of solar cells are thin film cells made by depositing one or more thin layers of photovoltaic material on a substrate. Material thickness ranges of the layers are measured in the nanometer to micrometer scales.

In contrast to silicon thin film type solar cells using layers of p-type and n-type doped silicon to liberate electrical energy from light, dye-sensitized solar cells (DSSCs) offer a generally more cost effective alternative thin film type solar cell. DSSCs employ a photo-electrochemical process for capturing and converting light energy into electrical power. A DSSC is structurally simpler than silicon thin film cells allowing them to be fabricated at a lower cost without all of the typical semiconductor foundry multi-layer formation and etching process steps often requiring highly specialized equipment and controlled process environments. DSSCs are also generally more robust than a silicon solar cells providing greater end use versatility in a variety of electronic devices and power supply applications. DSSCs, also known as Gratzel cells, are further described in U.S. Pat. Nos. 4,927,721 and 5,350,644 to Gratzel et al., each of which are incorporated herein by reference in their entireties.

FIG. 1 shows a conventional DSSC. A DSSC basically is comprised of a transparent anodic photoelectrode (aka “working electrode”) coated with a transparent electrically conductive oxide (TCO), a metalized cathodic counter-electrode typically coated with a conductive platinum or carbon film, and an electrolye comprising an oxidation/reduction (redox) system filled between the electrodes. The anodic electrode includes a thin layer of a porous nanocrystalline semiconductor material comprised of a metal oxide such as TiO2 (titania). The nanocrystalline material is coated with a photosensitizing dye having sensitizing dye molecules that are adsorbed onto the nanocrystalline material, thereby creating a photo-electrically “active” semiconductor material layer.

In operation, photoexcitation of the sensitizer dye molecules occurs via absorption of light energy. Negatively charged electrons liberated from the dye molecule atoms changed from a ground state to an excited state by photoexcitation migrate from the nanocrystalline semiconductor active layer and collect in the anodic electrode. The free electrons then flow through an external circuit which may utilize the electrical power produced and are re-introduced back into the DSSC via the metalized counter-electrode. The electrolyte via redox reactions essentially replenishes the lost electrons in the oxidized dye and the circuit is completed.

Despite the foregoing advantages of DSSCs, solar energy conversion efficiencies of conventional DSSCs have historically been lower than silicon thin film solar cells.

A DSSC with improved solar conversion efficiency is therefore desirable.

### SUMMARY OF INVENTION

The present invention provides a dye-sensitized solar cell (DSSC) offering improved solar conversion efficiency by incorporating a microlens array internally into the solar cell package. Microlens arrays according to embodiments of present invention improve internal light transmission and distribution throughout the porous nano-structured semiconductor active metal oxide layer that provides a support lattice for the charge carrier such as a photosensitive dye. This results in higher absorption rates of light by the dye and release of free electrons, thereby increasing current density and power output per given surface area of the solar cell package.

In some embodiments, the microlens arrays disclosed herein are preferably disposed internally with the DSSC package, and more preferably are interposed between the anodic electrode substrate and nano-structured active metal oxide layer. According to some possible embodiments, the microlens arrays may be comprised of a plurality of microlens elements that may be convex or concave in shape.

According to one embodiment of the present invention, a dye-sensitized solar cell includes an anodic electrode including an electrically conductive first substrate and a porous nano-structured active metal oxide layer supported thereon, which includes a sensitizer dye. The first substrate, which preferably is transparent, is positionable to receive incident light from a light source. A cathodic counter-electrode including an electrically conductive second substrate is spaced apart from the first substrate. A microlens array is disposed between the first substrate and the porous metal oxide layer, wherein the microlens array comprises a plurality of microlens elements operable to transmit and disperse light from the first substrate to the active metal oxide layer. The light maybe any light including light in the visible spectrum produced by the sun or artificial lighting. An electrolyte is filled between the first and second substrates.

According to another embodiment, a dye-sensitized solar cell with internal microlens array includes an anodic electrode including an electrically conductive first substrate and a porous nano-structured active metal oxide layer supported thereon. The first substrate being positionable to receive incident light from a light source. A cathodic counter-electrode including an electrically conductive second substrate is spaced apart from the first substrate. A sensitizer dye is adsorbed on the nano-structured metal oxide layer and an electrolyte is provided contacting the nano-structured metal oxide layer and preferably the counter-electrode to form an electrical path. In one embodiment, a microlens array is disposed between the first substrate and the porous metal oxide layer, wherein the microlens array comprises a plurality of microlens elements having a configuration selected from the group consisting of convex-shaped microlens elements and concave shaped microlens elements. Preferably, the microlens elements are arranged in a monolayer which engages the porous metal oxide layer and the first substrate or electrically conductive and light transmitting intervening metal oxide layer(s) formed on the first substrate. In some embodiments, the microlens elements may be convex microspheres or concave depression formed in the intervening metal oxide layer(s).

A method for forming an anodic electrode for a dye-sensitized solar cell is provided. In one embodiment, the method includes the steps of: providing a substrate coated with a transparent conductive oxide film; forming on the substrate a monolayer of microlens elements having a configuration selected from the group consisting of convex-shaped microlens elements and concave shaped microlens elements; and forming a porous nano-structured metal oxide layer on the monolayer. The microlens elements are operable to transmit and disperse light incident on substrate to the nano-structured metal oxide layer, thereby increasing exposure of sensitizer dye molecules adsorbed on the nano-structured oxide layer to light.

### BRIEF DESCRIPTION OF THE DRAWINGS

The features of the preferred embodiments will be described with reference to the following drawings where like elements are labeled similarly, and in which:

FIG. 1 is a schematic diagram graphically illustrating a conventional dye-sensitized solar cell (DSSC);

FIG. 2 is a schematic diagram showing a first embodiment of a DSSC having an internal convex microlens array;

FIG. 3 is a schematic diagram showing a second embodiment of a DSSC having an internal concave microlens array;

FIGS. 4-7 show process steps for forming a convex microlens array on a substrate according to the DSSC of FIG. 2;

FIGS. 8-11 show process steps for forming a concave microlens array on a substrate according to the DSSC of FIG. 3;

FIG. 12 is a top plan view of a convex microlens array comprising a plurality of convex microlens elements in the form of microspheres;

FIG. 13 is a top plan view of a concave microlens array comprising a plurality of concave microlens elements in the form of concave depressions formed in an oxide layer;

FIG. 14 is a scanning electron microscope image of a convex microlens array comprised of a monolayer of convex-shaped microlens elements.

FIG. 15 is a scanning electron microscope image of a concave microlens array comprised of a monolayer of concave-shaped microlens elements.

FIG. 16 illustrates one embodiment of an apparatus for forming a monolayer of microspheres in the formation of microlens elements;

FIG. 17 is a scanning electron microscope image of an array of microspheres and nanospheres captured during formation of microlens elements; and

FIG. 18 graphically illustrates laboratory test results of comparisons between performance of conventional DSSCs and DSSCs with internal microlens arrays.

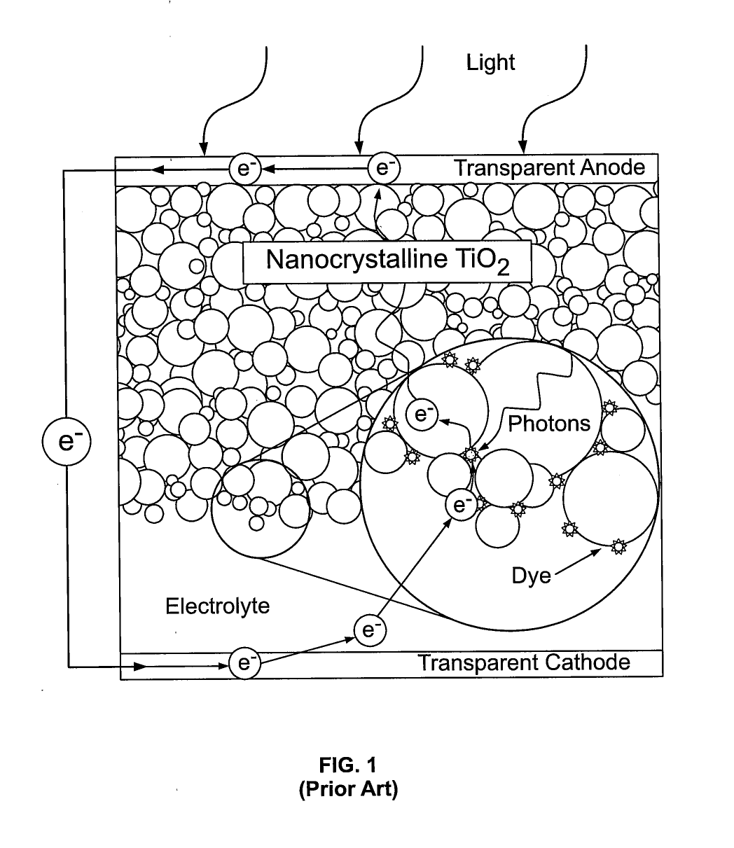

### DETAILED DESCRIPTION OF THE INVENTION

The features and benefits of the invention are illustrated and described herein by reference to preferred embodiments. Accordingly, the invention expressly should not be limited to such preferred embodiments illustrating some possible non-limiting combination of features that may exist alone or in other combinations of features; the scope of the invention being defined by the claims appended hereto. This description of preferred embodiments is intended to be read in connection with the accompanying drawings, which are to be considered part of the entire written description. The drawing figures are not necessarily to scale and certain features may be shown exaggerated in scale or in somewhat schematic form in the interest of clarity and conciseness. Accordingly, size, thicknesses, and spacing of various layers of materials or structures shown in the accompanying drawings are not limited to the relative sizes, thicknesses, or spacing shown in the accompanying drawings.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms used herein to describe the physical relationship between various elements, features, or layers such as “attached,” “affixed,” “connected,” “coupled,” “interconnected,” or similar should be broadly construed to refer to a relationship wherein such elements, features, or layers may be secured or attached to one another either directly or indirectly through intervening elements, features, or layers, as well as both movable or rigid attachments or relationships, unless expressly described otherwise. Similarly, the term “on” when used herein to describe the physical relationship between various elements, features, or layers should be broadly construed to include contact between one another that is direct or indirect through intervening elements, features, or layers, unless expressly described otherwise.

The present disclosure describes exemplary embodiments of a photo-electrochemical cell in the form of a dye-sensitized solar cell (DSSC) having an integrated microlens arrays. In one preferred embodiment, the microlens array is disposed internal to the solar cell between a semiconductor anodic substrate electrode and a cathodic substrate counter-electrode spaced part therefrom. In further preferred embodiments, the microlens comprises a single or monolayer of lens elements, which may be convex or concave in shape. The microlens array may be associated with and supported by the anodic substrate electrode.

The microlens array provides improved solar conversion efficiencies and higher current densities when compared to conventional dye-sensitized solar cells without microlens arrays. The microlens array is attributed with creating better dispersion of light through the nanocrystalline dye support structure, thereby increasing contact of light with the photosensitive dye molecules resulting in higher electron transfer rates and power output from the DSSC. In contrast to a conventional DSSC, embodiments of a DSSC with microlens array according to principles of the present invention allows the dye-sensitized solar cells to advantageously extract more electrical power from both natural sunlight, and importantly lower intensity indoor artificial lighting sources generally emitting a narrower spectrum of light that is convertible to electric power. Microlens-equipped DSSCs according to the present invention are therefore particularly well-suited for operating and/or recharging various electronic devices used indoors under artificial lighting conditions.

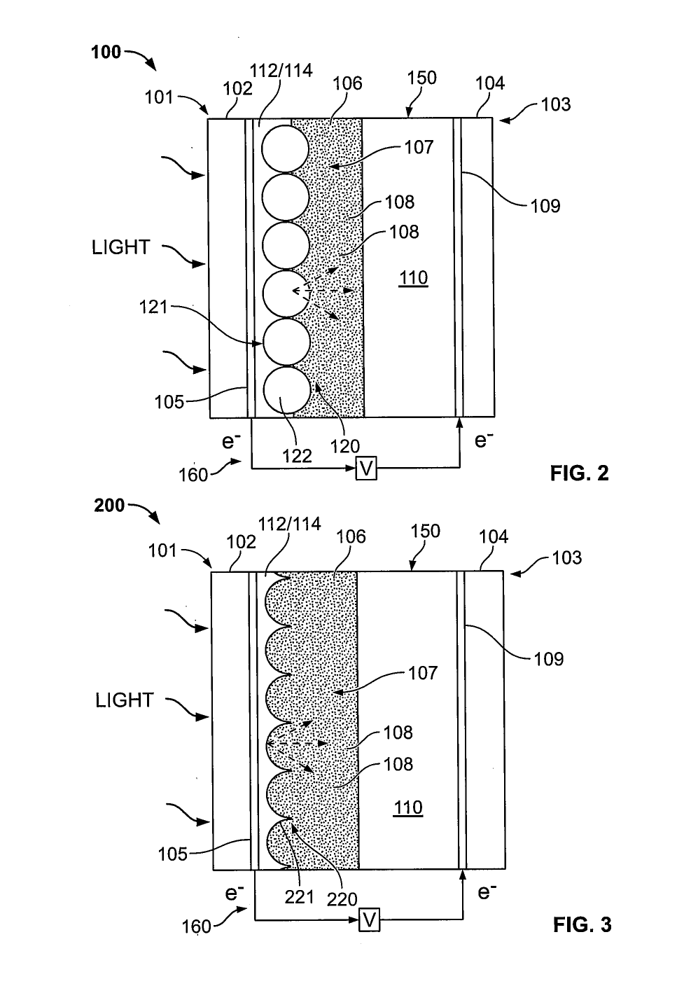

FIGS. 2 and 3 illustrate two possible, but non-limiting exemplary embodiments of a DSSC constructed according to principles of the present invention. DSSC 100 shown in FIG. 2 schematically illustrates an exemplary embodiment of a DSSC device having an internal convex microlens array 120 comprising a plurality of convex-shaped micron sized microlens elements. DSSC 200 shown in FIG. 3 schematically illustrates an exemplary embodiment of a DSSC device having an internal concave microlens array 220 comprising a plurality of concave-shaped microlens elements. Each embodiment will now be described in further detail.

Convex Microlens Arrays

Referring now to FIG. 2, DSSC 100 generally includes a semiconductor type electrode 101 including a first anodic coated substrate 102, a convex microlens array 120 supported thereon, a nano-structured semiconductor metal oxide film/layer 106 supported thereon, a photosensitizing dye 107 adhering or adsorbed thereon, and an opposing counter-electrode 103 including a second cathodic coated substrate 104 spaced apart from substrate 102. An electrolyte 110 is filled between the anodic and cathodic substrates 102 and 104.

In one embodiment, the anodic substrate 102 forming part of electrode 101 may be any conventional anodic substrate used in DSSCs such as preferably without limitation transparent glass substrate or a transparent rigid or flexible polymer substrate coated with a thin film of a TCO (thermally conductive oxide) material 105 to form an anode. The TCO film is applied on the underside of anodic substrate 102 facing the counter-electrode 103. Suitable TCOs that may be used include without limitation fluorine tin oxide (“FTO” or SnO₂:F), indium tin oxide (“ITO”), indium zinc oxide (“IZO”), antimony tin oxide (ATO), or any other suitable coating materials possessing the desired anodic properties.

In one embodiment, cathodic substrate 104 forming part of counter-electrode 103 may be any conventional cathodic substrate used in DSSCs such as preferably without limitation a transparent glass substrate or a transparent rigid or flexible polymer coated with a thin film containing a conductive metal material 109. In some embodiments, the conductive material may be without limitation platinum (e.g. “platinized glass”), carbon/graphite material, iron (Fe), aluminum (AI), titanium (Ti), nickel (Ni), copper (Cu), or tin (Sn), or any other suitable conductive coating materials possessing cathodic properties with respect to the anodic material. The thin metallic film is applied on the underside of cathodic substrate 104 facing the semiconductor electrode 102.

Suitable polymer base materials that may be used for anodic substrate 102 and cathodic substrate 104 include without limitation polyethylene terephthalate (PET), polycarbonate, polyimide, polyethylene naphthalate, polyether sulfone, polyethylene, polypropylene, and others.

Anodic and cathodic glass substrates are commercially available with the coating material already applied. TCO-coated glass commonly used in DSSCs is available from various manufacturers, including for example Asahi Glass Co., Ltd. of Tokyo, Japan, Praezisions Glas & Optik GmbH of Iserlohn, Germany, and others. Metalized or cathodic coated glass substrates such as platinized glass and others are commercially available from manufacturers such as Dyesol Co. of Queanbeyan, Australia and others.

With continuing reference to FIG. 2, anodic electrode 102 used in DSSC 100 further includes a conventional electrically conductive and light transmitting porous semiconductor nano-structured metal oxide layer 106 disposed proximate to and supported from anodic substrate 102 as further described herein. Oxide layer 106 is comprised of a plurality of metal oxide nanoparticles.

In some preferred embodiments, metal oxide layer 106 is mesoporous in structure containing pores with diameters that may be between about and including 2 to 50 nanometers (nm). This nano-structured metal oxide layer 106 transmits light to the photosensitive dye 107 adsorbed thereon. Mesoporous nano-structured metal oxide layer 106 provides a three-dimensional support scaffold or lattice having a large surface area for adsorbing the sensitizer dye 107, which is interspersed throughout the oxide matrix for photo-excitation by light incident on anodic substrate 102. Accordingly, porous metal oxide layer 106 is often referred to as the “active layer” in a DSSC since it is the site that supports electron transfer and exchange.

Nano-structured oxide layers 106 are well known in the art and may be comprised of nanometer-sized particles, tubes, rods, etc. and/or combinations thereof which are sintered at elevated temperatures together creating a mesoporous structure, thereby increasing the available surface area of the metal oxide layer 106 for adsorbing sensitizer dye 107. Average particle diameters may be in the range from about and including 1 nm to 5 microns for example. The dye 107, adhered via a thin film on and within metal oxide layer 106, operates to contribute and exchange electrons in a conventional manner in a DSSC as already described herein to convert light energy into usable electrical energy. The porous dye support nano-structured metal oxide layer 106 increases the working thickness and quantity of dye 107 which may be exposed to light for a fixed surface area of the DSSC, thereby increasing the solar energy conversion efficiency and concomitantly current output from the solar cell device.

Suitable representative commercially-available materials that may be used for nano-structured semiconductor metal oxide layer 106 include without limitation titanium dioxide (TiO2 aka titania), tin dioxide (SnO2), zinc oxide (ZnO), tungsten oxide (WO3), niobium oxide (Nb2O), titanium oxide strontium (TiSrO3), combinations thereof, and others. In one exemplary embodiment, metal oxide layer 106 may be made from crystalline TiO2 commonly used in DSSCs which is a high bandgap semiconductor that is substantially transparent to visible light and has excellent optical transmittance properties to disperse light to photosensitized dye 107 adhered to layer 106. The crystalline TiO2 may be in anatase form.

In some representative embodiments, without limitation, nano-structured metal oxide layer 106 may preferably have a thickness ranging from about and including 5 to 20 microns (μm). In one embodiment, oxide layer 106 has a thickness on the order of about 15 μm.

As noted, a conventional photosensitive or sensitizer dye 107 is used in DSSC 100 that operably absorbs light and contains the molecular sub-structure 108 that contributes electrons for forming an electrical circuit in the solar cell. Dye 107 may be any suitable commercially available dyes commonly used in DSSCs including, without limitation Ru-based (ruthenium) dyes, Os-based dyes (osmium), or any other suitable light absorbing photosensitive dyes. Nano-structured metal oxide layer 106 is immersed and soaked in a solution of the sensitizer dye and a solvent for a predetermined period of time in a conventional manner. When removed from the solution, a thin layer of dye 107 remains covalently bonded or adsorbed to nano-structured metal oxide layer 106.

Continuing now with reference to FIG. 2, electrolyte 110 provided in DSSC 100 fills the space between the anodic electrode and cathodic counter-electrode 101, 103 and may infiltrate the mesopores of nano-structured metal oxide layer 106. Electrolyte 110 may be liquid, gel, or solid in form. In some preferred embodiments, a gel or liquid type electrolyte is used. The porous nano-structured metal oxide layer 106, coated with dye 107 adhered thereto, is immersed or embedded in electrolyte 110 when DSSC 100 is fabricated to establish electrical contact between layer 106 and electrolyte 110. Electrolyte 110 operates to actively transport electrons through the solar cell and ultimately completes the electrical circuit between anodic electrode 101 and opposing counter-electrode 103.

In some embodiments, electrolyte 110 may be any commercially available electrolyte commonly used in DSSCs such as without limitation an iodine-based solution comprising an organic solvent containing a redox system, which may be provided by an iodide/triiodide redox-active couple dissolved in the solvent. Examples of other suitable commercially available electrolyte commonly used in dye-sensitized solar cells that may be used include without limitation bromide, hydroquinone, or other redox systems.

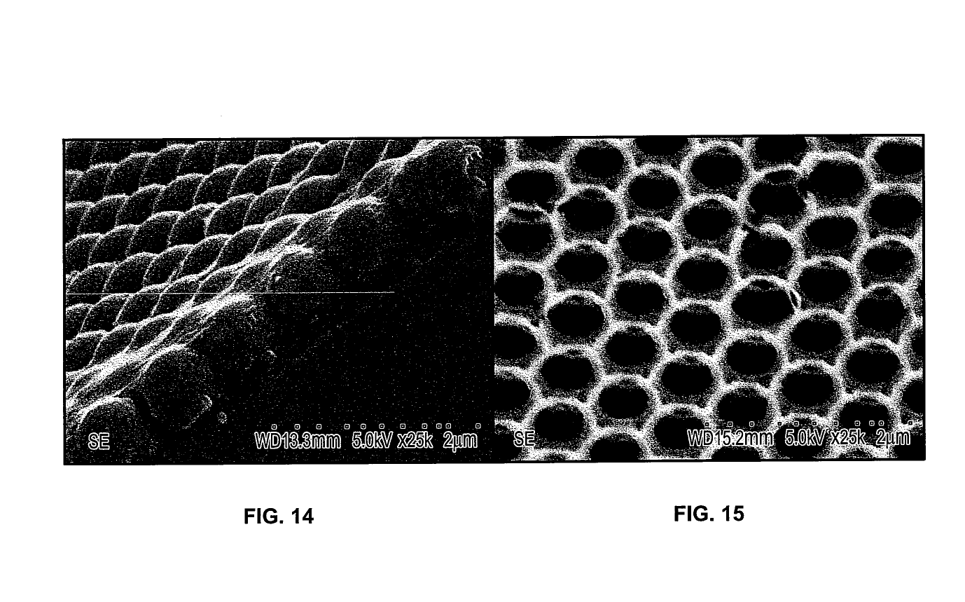

Convex microlens array 120 will now be described in further detail. Referring to FIGS. 2, 7, and 12, microlens array 120 advantageously enhances light distribution internally through the solar cell and improves the solar energy conversion efficiency and current output from the device. In one preferred embodiment, microlens array 120 is disposed between anodic substrate 102 and nano-structured metal oxide layer 106. Microlens array 120 is comprised of at least one monolayer of film containing a plurality of convex-shaped microlens elements 121, which receive and transmit light to nano-structured metal oxide layer 106. The microlens elements 121 are supported by anodic substrate 102. In one embodiment, each microlens element 121 may be comprise of a generally rounded microsphere 122 formed of a material that is operative to receive and transmit light. In one preferred embodiment, a single monolayer of microspheres 122 is provided forming a lens array film having a thickness (measured vertically and perpendicular to anodic substrate 1O2) that is substantially equal to the diameter D (identified in FIG. 5) of the microspheres. The SEM (scanning electron microscope) image in FIG. 14 shows an actual monolayer of microspheres 122 formed on a substrate.

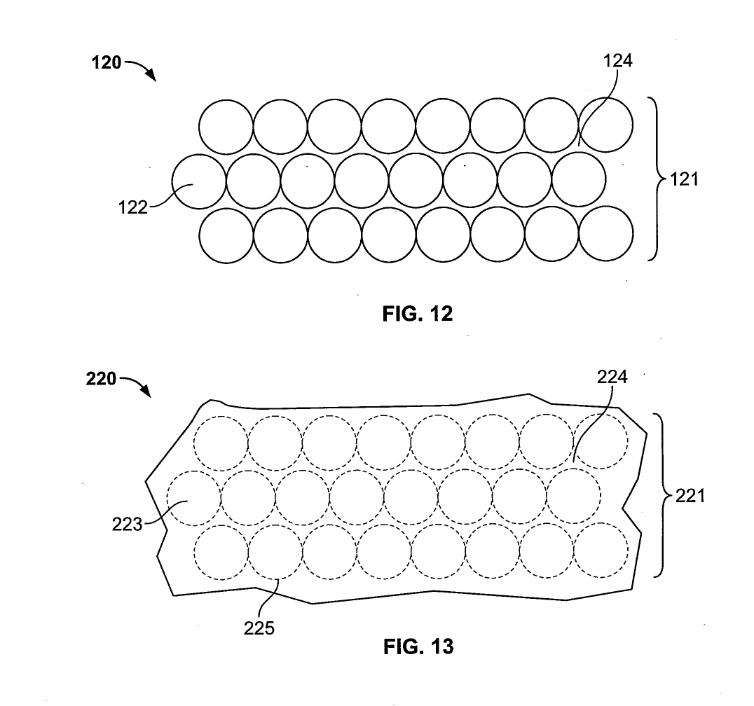

Microspheres 122 within a monolayer are preferably closely packed (laterally) being arranged in relatively close proximity to each other and/or may be abutting to form a substantially uniform matrix of laterally-extending microspheres on anodic electrode 101. FIG. 12 shows a top plan view of microspheres 122 with microspheres arranged in a series of rows in which the microspheres are in staggered relationship to microspheres in adjacent rows. The microspheres 122 may be hexagonally ordered in the array. The relatively close or abutting arrangement of microspheres 122 promotes minimal leakage of light bypassing the microspheres through the microlens array via the roughly diamond-shaped interstitial spaces 124 inherently formed between the microspheres and circumferential gaps that may exist between the microspheres (see FIG. 12 11). The lateral spacing or abutting relationship between microspheres 122 that may be achieved in practice will be determined in part by the microlens array 120 formation process used and control of process parameters.

Since the microspheres 122 may not be as electrically conductive as the metal oxides formed on anodic electrode 101, a single monolayer is generally preferred in some embodiments for the microlens array 120 to provide good electrical conductivity and optical transparency through the array while achieving the light distribution benefits of these microlens elements. However, in some embodiments contemplated, it may be desirable to vertically stack two or more monolayers of microspheres 122 to accommodate various end user purposes presently identifiable or arising in the future. Accordingly, the invention is not limited to single monolayer of microspheres 122.

Convex microlens elements 121 are operable to receive incident light from anodic substrate 102, and transmit and distribute the light throughout nano-structured metal oxide layer 106 which may be formed directly on and below the microlens array 120 in some embodiments as shown in FIG. 2. In some alternative embodiments contemplated, it is possible to deposit a very thin intervening layer of a TCO material such as without limitation TiO2 between nano-structured metal oxide layer 106 and microlens array 120 to increase electrical conductivity. However, such an intervening layer of material would counteract the light dispersion and refocusing effect of the microlens array and therefore if provided, should not be thick and solid. Accordingly, it is preferable, but not absolutely necessary that microlens array 120 be in direct contact with nano-structured metal oxide layer 106 to optimize the beneficial light dispersion action of the array.

In some possible embodiments, microspheres 122 may be formed of silicon (i.e. silicon dioxide or SiO2), a polymer, or any other suitable optically translucent or transparent material capable of transmitting light. According to some possible alternative embodiments, microspheres 122 may also possibly be formed of conductive materials which may have an electrical conductivity greater than silicon and some polymers, such as TiO2 or ZnO microspheres for example. These materials would possess the desired optical and light transmissions qualities, but could enhance electron transfer rates through the microlens array 120 and solar energy conversion efficiencies.

In other possible embodiments, each individual microsphere 122 may itself have a porous structure to enhance electrical conductivity through the microlens array 120. In some possible exemplary embodiments, therefore, a porous microsphere 122 may be formed that is composed of an aggregate of multiple spherical nanoparticles or beads adhered together thereby producing a microsphere having a porous structure. These porous microspheres 122 may be formed of TiO2 (titania) or ZnO in some embodiments.

The foregoing nanoparticles aggregates which may be used to form porous microspheres 122 are described, for example, in the following technical publications: D. Chen, L. Cao, F. Huang, P. Imperia, Y.-B. Cheng, R. Caruso “Synthesis of monodisperse mesoporous titania beads with controllable diameter, high surface areas, and variable pore diameters (14-23 nm),” J. Am. Chem. Soc. 132, (2010) 4438-4444; D. Chen, F. Huang, Y.-B. Cheng, R. Caruso “Mesoporous anatase TiO2 beads with high surface areas and controllable pore sizes: A superior candidate for high-performance dye-sensitized solar cells,” Adv. Mater. 21, (2009) 2206-2210; T. P. Chou, Q. Zhang, G. E. Fryxell, G. Cao “Hierarchically structured ZnO film for dye-sensitized solar cells with enhanced energy conversion efficiency,” Adv. Mater. 19, (2007) 2588-2592; H.-G. Jung, Y. S. Kang, Y.-K. Sun “Anatase TiO2 spheres with high surface area and mesoporous structure via a hydrothermal process for dye-sensitized solar cells,” Electrochimica Acta 55, (2010) 4637-4641; F. Sauvage, D. Chen, P. Comte, F. Huang, L.-P. Heiniger, Y.-B. Cheng, R. Caruso, M. Graetzel “Dye-sensitized solar cells employing a single film of mesoporous TiO2 achieve power conversion efficiencies over 10%,” ACS Nano 4, (2010) 4420-4425; F. Sauvage, F. Di Fonzo, A. Li Bassi, C. S. Casari, V. Russo, G. Divitini, C. Ducati, C. E. Bottani, P. Comte, M. Graetzel “Hierarchical TiO2 photoanode for dye-sensitized solar cells, “Nano Letters 10, (2010) 2562-2567; E. Thimsen, N. Rastgar, P. Biswas “Nanostructured TiO2 films with controlled morphology synthesized in a single step process: Performance of dye-sensitized solar cells and photo watersplitting,” J. Phys. Chem. C 112, (2008) 4134-4140; and W.-G. Yang, F.-R. Wan, Q.-W. Chen, J.-J. Li, D.-S. Xu “Controlling synthesis of well-crystallized mesoporous TiO2 microspheres with ultrahigh surface area for high-performance dye-sensitized solar cells,” J. Mater. Chem. 20, (2010) 2870-2876; all of which are incorporated herein by reference in their entireties.

In some representative preferred embodiments, without limitation, microspheres 122 may have a diameter in the range from about and including 0.25 μm to about and including 10 μm. Microspheres in this size range are intended to produce the desired optical and light dispersion properties and benefits of the microlens array resulting in improved solar conversion efficiency. In one exemplary embodiment, without limitation, microspheres having a diameter of about 1 μm have been successfully tested by the inventors with an increase in solar conversion efficiency, as further described herein. It will be appreciated that any suitable size microspheres 122 may be used that are larger or smaller than the foregoing exemplary range of sizes so long as the desired light dispersion performance and improvement in solar conversion efficiency is obtained.

With reference to FIGS. 2 and 6, in some embodiments of convex microlens arrays 120, microspheres 122 may be embedded in a supporting underfill layer 114 formed of an electrically conductive and light transmitting metal oxide material suitable for use in a dye-sensitized solar cell. Prior to heat curing to achieve a more solidified form as further described herein, the preferably flowable supporting underfill layer 114 material is flowed into and fills the open spaces in the microlens array 120 between the microspheres 122, including the interstitial spaces 124 between microspheres (see FIG. 12), underneath (at least partially) microspheres, and circumferential or other gaps between adjacent microspheres.

Referring to FIGS. 6, 7, and 11, underfill layer 114 may have any suitable thickness Tu (measured vertically and perpendicular to anodic substrate 102 as shown for example in FIG. 6). In some exemplary embodiments, supporting underfill layer 114 may have a thickness Tu that is less than but preferably not equal to the height or diameter D (labeled in FIG. 5) of the microspheres 122 so that at least a portion of each microspheres is exposed above the underfill to transmit light directly into nano-structured metal oxide layer 106. Accordingly, microspheres 122 are preferably not completely buried beneath underfill layer 114 which would degrade the light transmissibility benefits of microlens array 120. In one representative, but non-limiting embodiment, underfill layer 114 may have a thickness Tu that is approximately equal to half the height or diameter D of the microspheres 122 (as shown in FIG. 6) which may be considered optimal for improved solar conversion performance. Accordingly, in some exemplary embodiments where microspheres 122 having a diameter D of about +/−1 μm may be used, supporting fill layer 114 may have a thickness of about +/−0.5 μm. Thicknesses Tu of underfill layer 114 more or less than half the diameter D of microspheres 122 are also associated with improved performance.

Underfill layer 114 may be made of any suitable conducting, optically transparent metal oxide. In one exemplary embodiment of DSSC 100, a relatively transparent crystalline form of TiO2 (after heat curing) may be used for supporting underfill layer 114. Other suitable metal oxide materials capable of transmitting light and being electrically conductive may be used such as without limitation ZnO or others. Accordingly, the invention is not limited to any particular metal oxide for forming underfill layer 114.

It should be noted that in some embodiments, a further electrically conductive and light transmitting ultra-thin metal oxide base layer 112 may first be deposited directly onto anodic substrate 102 before microspheres 122 and supporting layer 112 to provide a base for holding the microspheres. Base layer 112 is therefore positioned between the metal oxide supporting underfill layer 114 and anodic substrate 102. This ultra-thin base layer 112 improves adhesion between the microspheres 122 and anodic substrate 102. After the layer of microspheres 122 are deposited on base layer 112, material for supporting underfill layer 114 may then be flowed into and backfilled between the microspheres as further described herein such that the supporting layer 114 oxide material will become conjoined with the base layer 112 oxide material at their interface. This forms a contiguous conductive layer and electron charge pathway from nano-structured metal oxide layer 106 through supporting underfill layer 114 and conjoined base layer 112 to anodic substrate 102.

Ultra-thin base layer 112 therefore is preferably formed of any suitable optically transparent material that is electrically conductive and transmits light, and which preferably increases the wettability or hydrophilicity of anodic substrate 102 to enhance adhesion of the microlens array 120 to the substrate. In various embodiments may be made of material the same as or different than microsphere supporting underfill layer 114. In some exemplary embodiments, for example, base layer 112 may be crystalline TiO2 or ZnO and supporting layer 114 may be formed of the same or a different material. In other possible embodiments, the desired surface functionalization of anodic substrate 102 could be achieved through the use of conventional corona discharge to make the surface hydrophilic for the purpose of coating microlens arrays. Accordingly, it will be appreciated by those skilled in the art that a discrete base layer 112 need not be provided so long as anodic substrate 102 has surface properties sufficient to produce a good bond or adhesion of the microlens array 120 to the substrate.

During fabrication of semiconductor anodic electrode 101 for DSSC 100, as further described herein, base layer 112 may flow and fuse with overlying supporting underfill layer 114 by the application of heat thereby forming a substantially monolithic layer 112/114 of material for supporting microspheres 122 and establishing the electrical path between anodic substrate 102 and nano-structured metal oxide layer 106. After heat curing, base layer 112 also becomes relatively transparent for light transmittance.

Ultra-thin base layer 112 need only have a film thickness sufficient to promote good adhesion of microspheres 122 to anodic substrate 102. In one embodiment, base layer 112 transforms the surface properties of the TCO anodic material on anodic substrate 102 to the TCO more hydrophilic for attracting and retaining microspheres 122 during the electrode fabrication process to be described herein. In exemplary embodiments, therefore, base layer 112 may have a thickness in the nanometer range. In one representative example, without limitation, base layer 112 may have a representative thickness on the order of about 20 nm which has been found to be generally sufficient for providing effective adhesion between microspheres 122 and anodic substrate 102.

Base layer 112 is preferably kept relatively thin since it is desirable that microlens array 120 is in relatively close proximity to anodic substrate 102 for directly receiving light from substrate 102 and then transmitting this light internally into nano-structured metal oxide layer 106 formed immediately below on the microlens array with minimal impedance by layer 112. Accordingly, base layer 112 preferably has a thickness which is substantially less than supporting underfill layer 114 measured in the micron range, and also less than the diameter D of the microspheres 122.

In other possible embodiments, it will be noted that base layer 112 may be omitted entirely and microlens array 120 may instead be formed directly on anodic substrate 102 so long as the method used to deposit microspheres 122 on anodic substrate 102 provides satisfactory adhesion.

Concave Microlens Arrays

According to another aspect of the invention, FIG. 3 shows DSSC 200 having an internal concave microlens array 220 comprising a plurality of concave-shaped microlens elements 221. DSSC 200 generally contains the same structures and components as DSSC 100 already described above, including a conventional semiconductor type electrode 101 including a first anodic coated substrate 102, a nano-structured semiconductor metal oxide layer 106 supported thereon, a photosensitizing dye 107, an electrolyte 110, and an opposing counter-electrode 103 including a second cathodic coated substrate 104 spaced apart from substrate 102. In lieu of a convex microlens array 120, however, DSSC 200 instead has a concave microlens array 220 supported from the semiconductor anodic electrode 101.

Referring to FIGS. 3 and 13, concave-shaped microlens array 220 is disposed between anodic electrode 101 and cathodic counter-electrode 103, and preferably between anodic substrate 102 and nano-structured metal oxide layer 106 in a similar manner to convex microlens array 120. Microlens array 220 functions in a similar manner to microlens array 120 to transmit and better disperse light to nano-structured metal oxide layer 106 and dye 107 adsorbed thereto.

Preferably, a thin monolayer of concave microlens elements 221 are formed as an integral part of a metal oxide film, which in one embodiment without limitation may be underfilled by layer 114. Microlens elements 221 are formed by preferably closely packed concave-shaped depressions 223 disposed in a monolayer (see, e.g. FIGS. 11 and 13) and may be produced according to an exemplary method further described herein. In one embodiment, as shown in FIG. 3, the concave depressions 223 defining microlens elements 221 may preferably face nano-structured metal oxide layer 106.

Microlens elements 221 are preferably arranged in tightly packed close proximity to each other as shown in FIG. 13 and the SEM image of an actual array in FIG. 15. Microlens elements 221 in adjacent rows are arranged in staggered relationship to each other as shown. Microlens elements 221 may be slightly spaced apart, and in some configurations may be separated by only an annular edge or rim 225 between adjacent depressions 223. An annular edge or rim 225 is defined by each concave depression 223 at the intersection of the depression with flat interstitial lands 224 formed between adjacent concave depressions 223 as best illustrated in FIG. 13.

Microlens Array Formation Process

A method for forming an anodic semiconductor electrode 101 for a DSSC having a microlens array film containing a plurality of convex or concave microlens elements 121, 221 will now be described. A method for assembling a DSSC integrating the microlens array will then be further described.

Convex microlens array 120 and concave microlens array 220 may be formed on anodic substrate 102 by any suitable method conventionally used in the art. Examples of methods that may be used for particle deposition include without limitation rapid convective deposition, spin coating, epitaxy, optical tweezers, and electrophoretic assembly. These processes are familiar to those skilled without further description.

One preferred exemplary method for forming an internal microlens array for a DSSC according to principles of the present invention is the convective deposition process which will now be briefly described. This process essentially forms a crystal on a substrate through convective self assembly of colloidal particles in two dimensional (2D) crystals. As further described below, the convective deposition process generally is accomplished by vertically withdrawing a hydrophilic substrate from a diluted particle suspension, wherein colloidal particles crystallize on the substrate in the thin film following the receding meniscus.

In contrast to the other foregoing techniques noted for forming films or material layers on a substrate, the convective deposition process advantageously permits formation of two dimensional microlens array (i.e. monolayer of convex or concave microlens elements extending laterally in two directions within a single plane) in a single step and less time, and further is commercially scalable and readily controllable for commercial production of DSSC microlens arrays. The convective deposition process is less complex than some of the foregoing layer deposition techniques. In addition, the operating costs of the convective deposition process may also be less since the process may be conducted under ambient room conditions (temperature and atmospheric pressure) without the use of specially controlled and/or heated process environments.

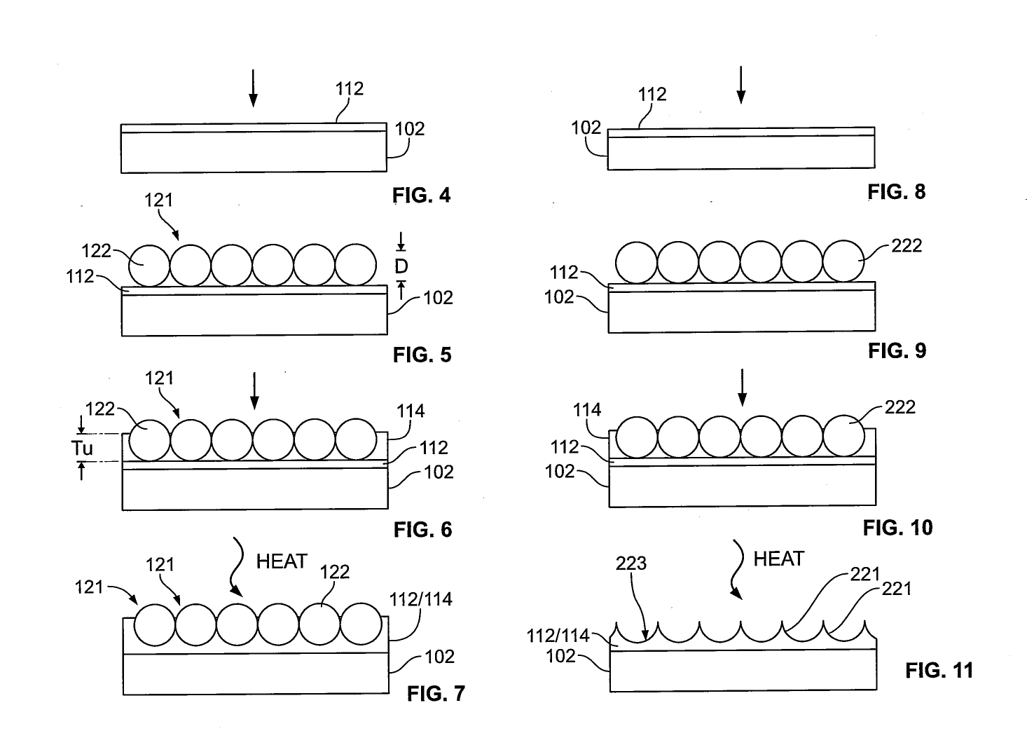

It should be noted that the convective deposition process to now be described is applicable to the formation of both internal convex microlens arrays 120 and internal concave microlens arrays 220, with some slight variations in the process steps and materials to be further explained. FIGS. 4-7 show sequential steps for forming convex microlens array 120. FIGS. 8-11 show sequential steps for forming concave microlens array 220. For the sake of brevity, these processes will be described together where steps are common to forming both convex and concave microlens arrays, with the distinguishing or additional steps required for either process explained.

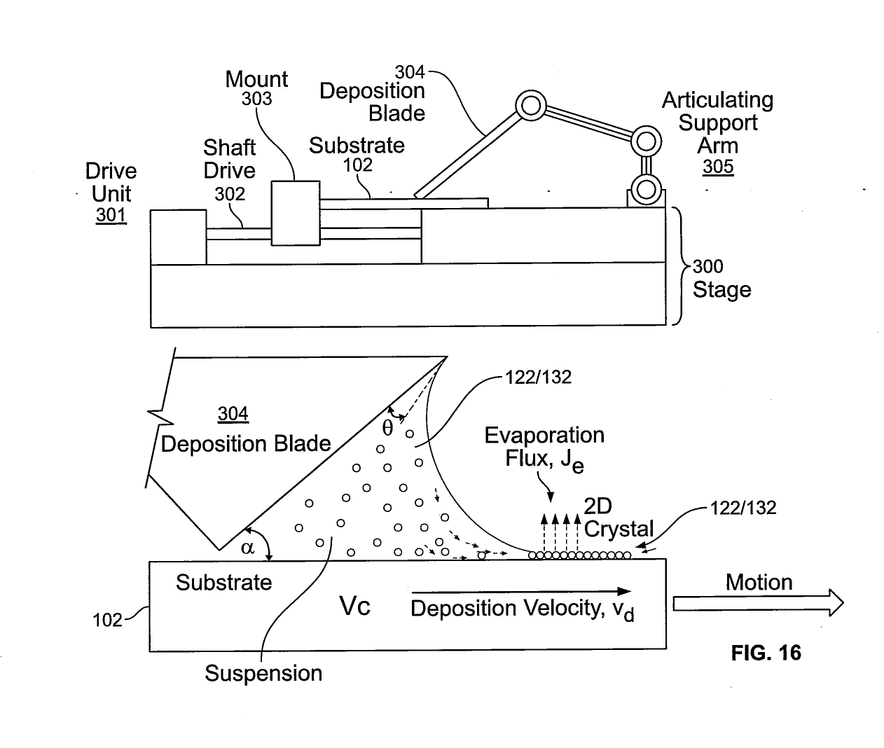

FIG. 16 schematically illustrates one embodiment of a basic apparatus setup for forming microlens arrays 120, 220 via the convective deposition process and pertinent process parameters.

As shown in FIG. 16, the deposition apparatus essentially includes a stationary stage 300, a linear drive unit 301 and coupled drive shaft 302, a mount 303 coupled to the drive shaft which imparts linear motion to the mount, and anodic substrate 102 supported by the mount and movable therewith. A deposition blade 304, which may be a glass or plastic substrate is suspended and positioned over the anodic substrate 102 via an articulating arm 305 attached to the stage. Deposition blade 304 is preferably angled to substrate 102 at a blade angle α between about and including 20° to about and including 90°.

In FIG. 16, the angle θ is the contact angle formed by the particle suspension with the coating or deposition blade 304. This contact angle θ changes the radius of curvature of the meniscus of the suspension, which changes the internal pressure and therefore affects the needed deposition speed to deposit a monolayer. In experiments conducted by the inventors, contact angle θ on the deposition blade 304 typically was found to be roughly the same as the blade angle a between deposition blade 304 and substrate 102. This process is further described in the technical article P. Kumnorkaew, Y. Ee, N. Tansu, and J. F. Gilchrist, “Investigation of the Deposition of Microsphere Monolayers for Fabrication of Microlens Arrays”, Langmuir, 24 (21), 12150-12157, 2008, which is incorporated herein by reference in its entirety.

The method for forming a microlens array 120, 220 on an anodic semiconductor electrode 101 using the foregoing convective deposition apparatus will now be described in further detail.

Referencing initially FIG. 4 (convex microlens array 120 formation) and FIG. 8 (concave microlens array 220 formation) showing the starting point for each type microlens array fabrication process, the method for forming microlens arrays 120, 220 each begins with a step of providing a transparent coated anodic substrate 102 as already described herein with the TCO layer 105. In some embodiments, where used, the preferred but optional ultrathin base layer 112 preferably formed of a conductive, light transmitting metal oxide material is next deposited on substrate 102 by any suitable conventional means commonly used in the art, such as without limitation the SOL-GEL process (as described in U.S. Pat. No. 4,927,721 which is incorporated herein by reference in its entirety, and in Stalder un Augustynski, J. Electrochem. Soc. 1979, 126, 2007). In one exemplary embodiment, base layer 112 may be TiO2 in a flowable amorphous and generally non-conductive state at the present point in the fabrication process. Any other suitable metal oxide materials, however, may be used as already discussed. FIGS. 4 and 8 show TCO-coated anodic substrate 102 with ultrathin base layer 112 deposited thereon.

When used with the convective deposition process, it should be noted that base layer 112 is especially beneficial because it makes anodic substrate 102 more hydrophilic which improves the attraction, ordering, and cohesion of microspheres 122 and micro-polystyrene beads 222 to the substrate. Accordingly, depending on the microlens formation process used, the use of base layer 112 may be beneficial for these advantages but is not absolutely required. Accordingly, the invention is not limited to the provision of base layer 112 alone.

As next shown in FIGS. 5 and 9, microspheres 122 (for convex microlens arrays 120) or micro-polystyrene beads 222 (for concave microlens arrays 220) are next deposited respectively on anodic substrate 102 using the convective deposition process in this non-limiting example. Formation of convex microspheres 122 will first be described.

The rate of crystallization in formation of microlens array 120 with microspheres 122 may be described by the following equation:

$$Vw - Vc - \frac{W}{0.605} \frac{Je ϕ}{d ( 1 - ϕ )}$$

Where: Vw (alternatively Vd in FIG. 16)=deposition speed or rate; Vc=crystal formation speed or rate; W=width of deposition blade; Je=evaporation flux; φ=particle volume fraction; and d=particle size. In other forms of this equation used, W may be replaced by a deposition parameter β. β has constant value between 0 and 1 depending on the particle-particle and particle-substrate interactions. For low volume fraction and electrostatically stable particles, β approaches 1 and decreases as particle-substrate interactions increase. This is further described in the technical article P. Kumnorkaew, Y. Ee, N. Tansu, and J. F. Gilchrist, “Investigation of the Deposition of Microsphere Monolayers for Fabrication of Microlens Arrays”, Langmuir, 24 (21), 12150-12157, 2008, which is incorporated herein by reference in its entirety.

For forming convex microlens array 120, an aqueous suspension is prepared containing microspheres 122 and a polar solvent. In one embodiment, microspheres 122 may preferably be formed from silica (SiO2), which are commercially available from manufacturers such as Fuso Chemical Co., Japan, Polysciences, Warrington, Pa., Spherotech, Lake Forest Ill., and others, or synthesized using Stöber synthesis or L-Lysine mediated methods as described in Stöber, J. Colloid Interface Sci. 1968, 26, 62; Davis, Chem. Mater. 2006, 18, 5814; Fan, Nature Materials, 2008, 7, 984.

The polar solvent may be dionized water (DI), ethanol, or another suitable solvent. In one representative example, without limitation, a suspension may be prepared with a particle concentration of microspheres 122 in the range of about and including 10-20 μl silica suspension at a silica particle volume fraction φ=20%. In one embodiment, a 10 μl at φ=20%. may be used. Other ranges of particle concentrations for suspensions may be used for silica or other colloidal particle materials that may be used to form microspheres 122 depending on the actual process parameters employed and size of microspheres to be used.

To continue the microlens formation process, anodic substrate 102 is first attached to the mount 303 as shown in FIG. 16. Deposition blade 304 is then positioned at an angle α to anodic substrate 102 and with the tip of the blade in close proximity or touching the upper surface of the substrate. Since substrate 102 will move from left to right as shown by the directional arrows in FIG. 16, the tip of deposition blade 304 is preferably positioned closer to the right edge of anodic substrate 102 than the left edge.

With continuing reference to FIG. 16, the microlens formation process continues with depositing and forming the convex microlens array 120 of microlens elements 121 on anodic substrate 102 as shown in FIG. 5. In a preferred embodiment, microlens array 120 is formed by a monolayer of microspheres 122. Anodic substrate 102 is progressively pushed through the prepared silica-containing suspension (disposed and held between substrate 102 and deposition blade 304 by as shown in FIG. 16 via capillary action) in an axial direction by linear drive unit 301 at deposition velocity Vd towards the right (as viewed in FIG. 16). As anodic substrate 102 moves through and emerges from the suspension, the aqueous component of the suspension evaporates (at the evaporation flux or rate Je) depositing the particulate microspheres 122 preferably a single monolayer of microspheres on substrate 102 as shown in FIG. 5. The colloidal silica microspheres 122 are ordered and aligned into a laterally extending array through convective self assembly.

Preferably, the deposition rate or speed (Vd) is balanced with the evaporation rate or flux (Je) to optimize the flux of microspheres 122 into the developing thin film for preferably forming a microlens array 120 comprised of a single two-dimensional (“2D”) monolayer of microspheres 122. Control of the process to produce a monolayer film of microspheres will also be dependent at least in part on the microsphere material and size, volume fraction φ of microspheres in the suspension, type of solvent used in the suspension, temperature under which the process is performed, and blade angle α which will affect the evaporation rate or flux.

With respect to FIG. 16, as the anodic substrate 102 is pulled away from the microspheres suspension, particles from the suspension continue to move to the contact line in evaporation-driven liquid flow in the thin film region and through convective flow from the moving substrate. The particles (microspheres) most often self-assemble into a hexagonal close-packed structure at the crystal front due to the large capillary force generated when the particles are confined in the thin film near the air/liquid/substrate contact line. For a monolayer crystal growth, the contact line is assumed to be the crystal front; that is, the height of the meniscus at the crystal front must equal the particle diameter. If the meniscus height at the crystal front is less than the particle diameter, as in the case of higher rate deposition conditions, the incoming particles will not form a close-packed structure.

On the contrary, for slower deposition speeds, if the height of the crystal front is greater than the particle diameter, a multilayer deposition instead may occur. A monolayer of particles with a random hexagonal close-packed structure may most often be formed at a single optimal deposition speed at a specified blade angle for a pre-selected set of process and raw material parameters described herein. For deposition speeds above and below the optimal speed that forms a monolayer, undesirable sub-monolayer and multilayer depositions may be produced.

In one representative example of the microsphere deposition process conducted by the inventors using a monodisperse suspension containing only silica microspheres 122, deposition speed's or velocities Vd in the range from about and including 30-70 μm/s were used with a 10 μl silica suspension at a silica microsphere 122 volume fraction φ=20% and silica particle size of about 1 μm that produced a closely packed and well ordered monolayer of microspheres 122 on an anodic substrate 102. The microspheres deposition process was conducted at ambient room temperatures, which may generally range without limitation from about and including 65 to 80 degrees F. for example, and therefore does not require an elevated heated process environment thereby advantageously minimizing energy consumption for the process.

It is well within the ambit of those skilled in the art to select the appropriate deposition velocity, blade angle, and other raw material and process parameters to produce a monolayer microlens array of microspheres 122 without undue experimentation based on the guidance provided herein and general knowledge existing in the art of the convective deposition process.

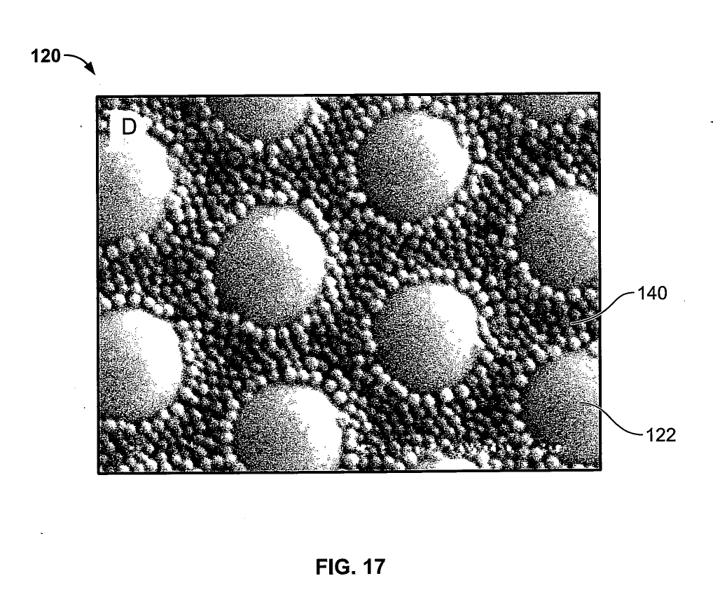

In some embodiments, with reference to FIG. 17, an optional processing agent such as sacrificial polystyrene (PS) nanoparticles 140 may be used in conjunction with the comparatively larger size silica microspheres 122 during formation of convex microlens arrays 120 for producing closely packed microsphere monolayer. An aqueous binary suspension containing the PS nanoparticles and silica microspheres may therefore be provided for forming a monolayer film of microspheres on anodic substrate 102. In some embodiments, PS nanoparticles 140 may be spherical in configuration in the form of nanospheres.

PS nanoparticles 140 are preferably smaller in size/diameter than microspheres 122. In some embodiments, without limitation, the PS nanoparticles 140 may have a diameter in the range from about and including 10 nm to about and including 200 nm, but preferably not larger than about ˜ 1/9th the diameter of the silica microspheres 122. Preferably, PS nanoparticles 140 should have surface chemistry that inhibits PS nanoparticles 140 adsorbing to silica microspheres 122 in solution prior to and during deposition. In one representative example of the microsphere deposition process conducted by the inventors, without limitation, PS nanoparticles 140 having a diameter of about 100 nm with carboxyl surface groups (negatively charged in water at pH 7.0) were used with silica microspheres having a diameter of about 1 μm (see, e.g. FIG. 17). However, other suitable sized nanoparticles and microspheres may be used so long as a closely packed and preferably uniform monolayer of microspheres 122 is produced. The sacrificial PS nanoparticles 140 function as a processing agent to facilitate formation of a close packed monolayer of microspheres in the microlens matrix during the convective deposition process. It has been found by the inventors that these PS nanoparticles beneficially may assist with ordering and aligning the larger silica microspheres 122 during formation of the microlens array on anodic substrate 102 by increasing colloid stability in the suspension. The PS nanoparticles 140 will congregate between adjacent microspheres 122 in the microlens matrix as shown in the SEM image of FIG. 17.

In one representative example of the microsphere deposition process conducted by the inventors, the coupling between the suspension properties and the deposition process during convective deposition of aqueous binary suspensions of 1 μm silica microspheres and 100 nm polystyrene (PS) nanoparticles 140 was evaluated. At conditions that produce a well-ordered microsphere 122 monolayer at a silica volume fraction of 20% in the absence of nanoparticles 140 (i.e. 0% nanoparticles in suspension) as processing agent using a monodisperse suspension containing only microspheres 122, the effect of varying the concentration of nanoparticles from and including 0% to 16% volume fraction on the quality of the microsphere deposition, surface morphology, and the exposure of the microspheres within the PS layer were examined. It was found that at low concentrations of PS nanoparticles, the deposition results in an instability that forms undesirable stripes parallel to the receding contact line. Optimum deposition was found to occur between from about and including 6% and 8% PS nanoparticle volume fraction concentration which forms a well-ordered monolayer of microspheres 122 having the same high degree of uniformity and density of microspheres as a monodisperse suspension containing only silica microspheres. For higher concentrations of PS nanoparticles, the deposition is increasingly less uniform as a result of nanoparticle depletion destabilizing the microspheres. Lower concentrations of PS nanoparticles 140 produce a layer of microspheres having only patchy areas with the desired surface morphology.

The foregoing convective deposition process steps described using either aqueous monodisperse suspensions of silica microspheres alone or optionally using binary aqueous suspension containing both microspheres and processing agent PS nanoparticles are further described in the American Chemical Society Journal of Surfaces and Colloids, “Effect of Nanoparticle Concentration on the Convective Deposition of Binary Suspensions,” by Pisist Kumnorkaew and James F. Gilchrist, Langmuir, 25 (11), 6070-6075, Apr. 27, 2009, which is incorporated herein by reference in its entirety. Accordingly, it is well within the ambit of those skilled in the art to employ either monodisperse or binary aqueous suspensions as described herein to form an internal microlens array for a DSSC without undue experimentation. The invention is not limited to convective deposition processes using only monodisperse suspensions alone, or further to the use of only convective deposition for forming a monolayer of microspheres 122 on a substrate.

In the event PS nanoparticles 140 are used as a processing agent in forming microlens array 120 as described above, a subsequent heating step in the microlens array formation process is required to melt and remove the sacrificial PS nanoparticles before depositing underfill layer 114 on the microlens array in FIG. 6. Otherwise, the underfill 114 will not remain attached to the TiO2 ultrathin layer 112 coated substrate 102 upon subsequent heating and curing of layers 112, 114 as further described herein. Therefore, following the formation of the microlens element 121 array shown in FIG. 5, anodic substrate 102 is preferably next heated (before depositing underfill layer 114 in FIG. 6) to a sufficient temperature to melt and remove PS nanoparticles 140 from the substrate, thereby exposing ultrathin base layer 112 beneath the microspheres 122. In one embodiment, this heating step may include heating anodic substrate 102 to about 240 degrees C. by any suitable conventional means used in the art, which may be sufficient to melt and remove the PS nanoparticles. The anodic substrate 102 is now prepared for underfilling.

Description of the method for forming microlens arrays on anodic substrate 102 will now continue with applying underfill layer 114.

After forming a monolayer of microspheres 122 on anodic substrate 102 as described above and shown in FIG. 5, supporting underfill layer 114 is next added as the process continues as shown in FIG. 6. Underfill layer 114 may be applied by any suitable method commonly used in the art including without limitation a SOL-GEL process, convective deposition, or others. Preferably, underfill layer 114 is applied in a manner wherein microspheres 122 are only partially submerged as shown in FIG. 6 so that at least a portion of the microspheres remains exposed to maximize light transmittance into nano-particle metal oxide layer 106 to be added below in a further step to be described. In one exemplary embodiment, underfill layer 114 may be a metal oxide such as TiO2 in a flowable amorphous and generally non-conductive state at the present point in the fabrication process. Any other suitable metal oxide materials, however, may be used as already discussed. In a preferred embodiment, base layer 112 underlying underfill layer 114 may similarly be made of the same amorphous TiO2.

Referring now to FIG. 7, heat is next applied to anodic substrate 102 to cure the amorphous TiO2 base and underfill layers 112, 114. The heat cure fully hardens and crystallizes the amorphous TiO2, making the layers 112, 114 electrically conductive and relatively transparent to better transmit light. The heat cure may further consolidate base and underfill layers 112, 114 into an essentially monolithic layer of material. The curing temperature will be dependent on the metal oxide material used for layers 112, 114. In one embodiment using amorphous TiO2 for layers 112, 114, the curing temperature may preferably be at least 400 degrees C. for at least 30 minutes, and in one representative example without limitation approximately 500 degrees C. for 5 hours to effectively crystallize the material. The heat cure may be performed by convective, infrared, and other heating methods capable of relatively uniform heating, but the resulting titania phase should be relatively insensitive to specific heating technique.

In the final steps for completing fabrication of anodic electrode 101, nano-structured metal oxide layer 106 (active layer) is formed directly onto the monolayer film of microspheres 122 and combined base-underfill layer 112/114 in a conventional manner which is well known in the art. In general, metal oxide layer 106 contains nanometer sized particles or structures as already described. Some starter materials used for forming metal oxide layer 106 such as TiO2 are typically available in paste and dispersion forms that may be applied by techniques including screen printing, blading, extrusion, spray, spin coating, or others.

Next, the uncured metal oxide layer 106 is then sintered at relatively high temperatures (e.g. approximately 500 degrees C. in some embodiments) thereby converting the starter material into a mesoporous nano-structure for holding photosensitizing dye 107. The sintering process generally also converts metal oxide material into a relatively transparent nano-structured film to better transmit light to the dye molecules.

In some embodiments, nano-structured metal oxide layer 106 preferably fully covers the microspheres 122 in the microlens array 120 and combined base-underfill layer 112/114 as shown in FIG. 2. In one representative example, without limitation, the active metal oxide layer 106 may have a film thickness on the order of about 15 μms. FIG. 2 shows the completed anodic electrode 101 with convex microlens array 120 disposed between active nano-structured metal oxide layer 106 and anodic substrate 102.

Assembly of DSSC 100 with integral convex microlens array 120 may then be performed in the usual conventional manner well known in the art, including basically the steps of (with reference to FIG. 2): applying sensitizer dye 107 to the nano-structured metal oxide layer 106 formed on anodic substrate 102 such as by without limitation immersing metal oxide layer 106 on anodic electrode 101 in the sensitizer dye 107 to incorporate the dye into layer 106; removing the anodic electrode from the dye; positioning the cathodic counter-electrode 103 in opposing and spaced apart relationship to anodic electrode 101 by mounting each to a frame 150; filling the DSSC with electrolyte 110; and sealing the DSSC.

DSSC 100, which forms a photovoltaic power source or supply, is then ready for connection to an external electrical circuit 160 (FIG. 2) which may be part of any type of electric equipment or system including for example, without limitation, a power grid, a rechargeable battery charging circuit, consumer electronic devices, and others. The same is applicable to DSSC 200. Accordingly, there are virtually limitless applications of DSSC 100 or DSSC 200 where the power output, voltage, and current can be effectively used from these solar cells provided individually or electrically coupled together in a power supply system.

The method for completing formation of concave microlens array 220 for DSSC 200 may be accomplished in at least two slightly different process variations to the foregoing steps for forming convex lens array 120 as already described.

In a first method for forming concave microlens array 220, after the step shown in reference to FIG. 7 in which combined base-underfill layer 112/114 are heat cured and crystallized, the anodic electrode 101 may be subjected to conventional material etching processes used in art for fabricating semiconductor structures wherein microspheres 122 are preferably completely removed from the microlens matrix or array 120. As shown in FIGS. 11 and 15, this leaves concave shaped voids or depressions 223 in the metal oxide underfill layer 114, thereby forming microlens elements 221 having an imprinted negative shape and size which generally corresponds to at least a portion of the configuration and size of the removed microspheres 122.

It should be noted that the configuration of the concave depression 223 formed in underfill layer 114 will depend on the depth to which the microspheres 122 are submerged in the underfill. In some embodiments, depressions 223 may have a partial spherical shape as shown in FIGS. 11 and 15, and in some embodiments may be half-spherical in shape in instances where microspheres 122 were submerged half-way in underfill layer 114. In one representative embodiment, for example, use of 1 μm diameter microspheres 122 may produce a partial spherical shaped concave depression 223 having a depth of 0.5 μm. Other suitable depths may be used.

FIG. 15 shows a SEM image of a concave microlens array 220 having a plurality of concave microlens elements 221 formed in underfill layer 114.

Preferably, the etching method and materials selected for underfill layer 114 and microspheres 122 are selected so that removal of the microspheres does not substantially etch or remove material from layer 114 which is needed to form the concave microlens elements 221. Accordingly, microspheres 122 and metal oxide underfill layer 114 preferably have different etch selectivities to the etching agent and process selected to form concave microlens elements 221. Any suitable etching agent and process may be used including without limitation wet and gaseous etching processes.

In one representative example, without limitation, microspheres 122 may be made of silica, underfill layer 114 may be made of TiO2, and wet hydrofluoric acid etching may be used as the etching process to dissolve and remove the microspheres.

Following etching and removal of microspheres 122, nano-structured metal oxide layer 106 is formed as already described above. Assembly of DSSC 200 is then subsequently completed with the dye, electrolyte, and counter-electrode in the same manner described herein with respect to DSSC 100.

In an alternative second method for forming concave microlens array 220, a plurality of micron-sized polystyrene (PS) microspheres 222 are instead used in lieu of silica microspheres 122. PS microspheres 222 may have a range of sizes similar to silicon microspheres 122 described elsewhere herein being measured in microns. In one exemplary embodiment, the PS microspheres 222 may be approximately 1 μm in diameter. It should be noted that PS microspheres 222 are intended to be sacrificial and used to form concave-shaped microlens elements 221 (see, e.g. FIG. 11), but are distinguishable from the substantially smaller sacrificial PS nanoparticles 140 shown in FIG. 17 which may be used as a processing agent to produce a well-ordered microlens array. In some embodiments contemplated, PS nanoparticles 140 may be used as a processing agent with PS microspheres 222 to produce a well ordered microlens array in a similar manner to silica microspheres 122 as already described herein.

The monolayer formation process step shown in FIG. 9 creates a closely packed layer of PS microspheres 222. The subsequent underfill layer 114 addition process when using PS microspheres 222 is shown in FIG. 10 and performed similarly to that same step already described with reference to FIG. 6 and silica microspheres 122. During the heat curing of combined base-underfill layer 112/114 as now shown in FIG. 11, the PS microspheres 222 are melted and removed at the same time that layers 112/114 are crystallized. This leaves the concave depressions 223 in underfill layer 114 which define the concave microlens elements 221 as shown in FIG. 11 in a similar manner to that already described with etching and removal of the silica microspheres 122. Advantageously, however, the silica microsphere etching step is eliminated by using PS microspheres 222 to form concave microlens elements 221.

### COMPARATIVE EXAMPLES/TESTS

The performance of dye-sensitized solar cells (DSSCs) incorporating an internal convex microlens array 120 and a concave microlens array as disclosed herein were tested and validated by the inventors through a comparison with conventional DSSC arrangements without microlens arrays.

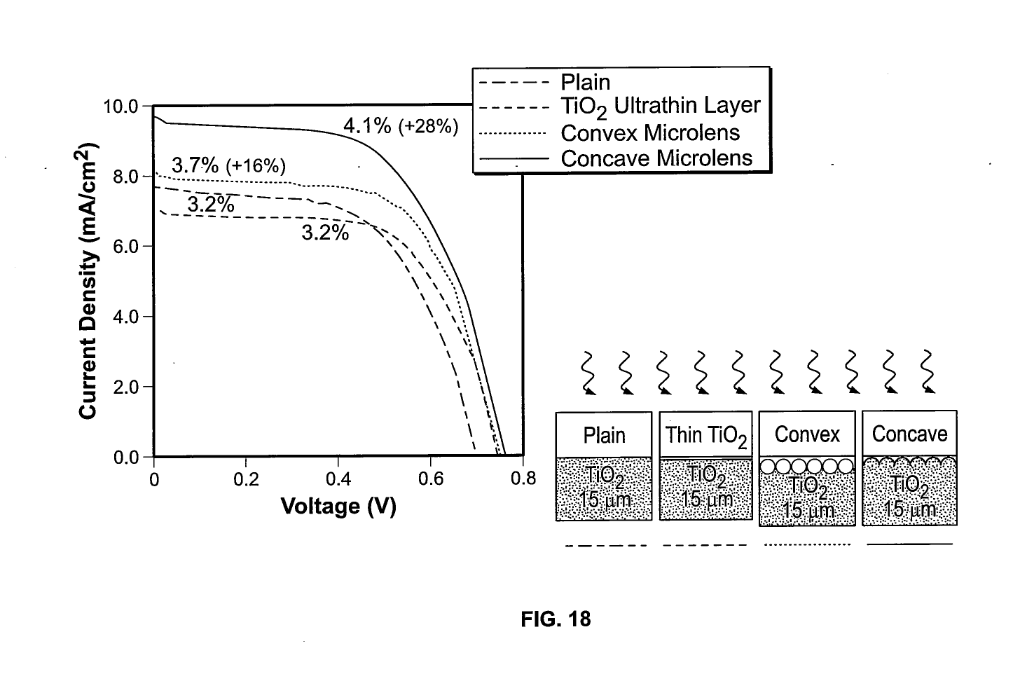

With reference to FIG. 18, a first baseline conventional DSSC was prepared according to methods well known in the art. This baseline DSSC included a conventional anodic electrode having an FTO coated substrate and a sintered nano-structured active metal oxide layer 106 formed directly thereon without any intervening films or layers (shown far left in FIG. 18, bottom right cross-sections). The active metal oxide layer had a film thickness of 15 μm.

A second DSSC was prepared that was identical to foregoing first baseline DSSC, but which further included an ultrathin film 112 of TiO2 with a thickness of 20 nm that was interposed between the FTO anodic substrate and nano-structured active metal oxide layer (shown second from left in FIG. 18, bottom right cross-sections).

A third DSSC 100 was prepared that was identical to the foregoing second DSSC. However, this DSSC further included an internal convex microlens array 120 that was formed according to the foregoing exemplary method disclosed herein (see, e.g. FIGS. 4-7 and accompanying description herein). The microlens array 120 was interposed between the ultrathin 20 nm film 112 of TiO2 and nano-structured active metal oxide layer (shown second from right in FIG. 18, bottom right cross-sections). The microlens array 120 included a monolayer of microlens elements 121 comprised of 1 μm diameter microspheres of silica.

A fourth DSSC 200 was prepared that was identical to the foregoing second DSSC. However, this DSSC further included an internal concave microlens array 220 that was formed according to the foregoing exemplary method disclosed herein (see, e.g. FIGS. 8-11 and accompanying description herein). The microlens array 220 was interposed between the ultrathin 20 nm film 112 of TiO2 and nano-structured active metal oxide layer (shown far right in FIG. 18, bottom right cross-sections). The microlens array 220 included a monolayer of microlens elements 221 comprised of 0.5 μm depth concave depressions 223 having a half-spherical shape. The concave depressions 223 were formed in a 0.5 μm thick TiO2 underfill layer 114 as already described herein, with the depressions 223 being approximately 0.5 μm in depth.

Each of the foregoing four test DSSCs further used a standard Pt-coated counter-electrode, N719 sensitizer dye, and an iodine-based electrolyte (dimethyl propyl imidazolium iodide (0.6 M), lithium iodide (0.1 M), iodine (0.05 M), and tert-butylpryidine (0.5 M) in acetonitrile as prescribed by The Japan Society of Applied Physics: Yasuo CHIBA, Ashraful ISLAM, Yuki WATANABE, Ryoichi KOMIYA, Naoki KOIDE and Liyuan HAN, “Dye-Sensitized Solar Cells with Conversion Efficiency of 11.1%”, Japanese Journal of Applied Physics, Vol. 45, No. 25, 2006, pp. L638-L640). A 1 cm square DSSC area was fabricated and tested for all four DSSCs.

The standard test procedure for dye-sensitized solar cells specified in the aforementioned reference was followed. Each of the foregoing DSSCs prepared were each in turn coupled to an electrical circuit for current and voltage measurements via standard electrical metering equipment. The anodic substrates 102 of each DSSC was then exposed to a standard 100 mW/cm² incident irradiance with an AM 1.5 G filter (1.5 air mass spectrum) to simulate natural sunlight radiation. The tests were performed at the standard 25 degrees C.

Electrical measurements were then recorded during tests of each of the four test DSSCs. Solar conversion efficiency based on these measurements was calculated by the following standard known formula:

Solar Conversion Eff.=(Imax Vmax/A)/(100 mW/cm²)

Where: Imax=circuit current at maximum cell output power; Vmax=circuit voltage at maximum cell output power; A=surface area.

### Test Results

The test results for the foregoing four exemplary DSSC constructions are shown in the graph at left in FIG. 18. Both the first baseline DSSC and second DSSC with ultrathin TiO2 film yielded essentially the same maximum solar conversion efficiency of 3.2%. The open circuit voltage increased and the short circuit current density decreased as compared to the untreated sample. Accordingly, there was no efficiency gain with addition of the ultrathin TiO2 film in comparison with the standard baseline DSSC.

DSSC 100 with internal monolayer convex microlens array 120 however produced a 16% improvement over the standard baseline DSSC and second DSSC with ultrathin TiO2 film. The calculated solar conversion efficiency was 3.7%.

Unexpectedly, DSSC 200 with internal monolayer concave microlens array 220 formed in TiO2 underfill layer 114 outperformed DSSC 100 with the silica microspheres 222 lens array. DSSC 200 produced a 28% improvement over the standard baseline DSSC and second DSSC with ultrathin TiO2 film. The calculated solar conversion efficiency was 4.1%.

The test results therefore demonstrated that an improvement in solar energy conversion efficiency improvement can be realized using either convex or concave internal microlens arrays formed according to embodiments of the present invention.

It will be appreciated that internal microlens arrays formed according to principles of the present invention may be used with equal benefit for improving solar conversion efficiency of DSSCs for using both natural and artificial light including wavelengths in the visible spectrum.

While the foregoing description and drawings represent the preferred embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed is:

1. A dye-sensitized solar cell comprising:
an anodic electrode including an electrically conductive first substrate and a porous nano-structured active metal oxide layer supported thereon, the first substrate being positionable to receive incident light from a light source;
a cathodic counter-electrode including an electrically conductive second substrate spaced apart from the first substrate; and
a microlens array disposed between the first substrate and the porous metal oxide layer, wherein the microlens array comprises a plurality of microlens elements operable to transmit light.

2. The dye-sensitized solar cell of claim 1, wherein the microlens elements are further operable to transmit light incident on the first substrate to the active metal oxide layer.

3. The dye-sensitized solar cell of claim 1, wherein the nano-structured active metal oxide layer comprises a porous sintered material selected from the group consisting of titanium dioxide (TiO2), tin dioxide (SnO2), zinc oxide (ZnO), tungsten oxide (WO3), niobium oxide (Nb2O), titanium oxide strontium (TiSrO3), and combinations thereof.

4. The dye-sensitized solar cell of claim 1, wherein the microlens array is further disposed between the anodic electrode and cathodic counter-electrode.

5. The dye-sensitized solar cell of claim 1, wherein the microlens elements have a configuration selected from the group consisting of a convex shape and a concave shape.

6. The dye-sensitized solar cell of claim 5, wherein the microlens elements comprise a plurality of microspheres having a convex shape.

7. The dye-sensitized solar cell of claim 6, wherein the microspheres are made of silica.

8. The dye-sensitized solar cell of claim 6, further comprising a supporting underfill layer filled between interstitial spaces between the microspheres, the underfill layer being made of an electrically conductive metal oxide.

9. The dye-sensitized solar cell of claim 5, wherein the microlens elements comprise a plurality of concave depressions formed in a metal oxide layer of material, the metal oxide layer being operable to transmit light.

10. The dye-sensitized solar cell of claim 9, wherein the concave depressions have a partial spherical shape.

11. The dye-sensitized solar cell of claim 1, wherein the microlens array comprises a monolayer film of the microlens elements.

12. The dye-sensitized solar cell of claim 1, further comprising a photosensitizing dye adsorbed on the nano-structured active metal oxide layer.

13. The dye-sensitized solar cell of claim 1, wherein the first substrate includes a transparent conductive oxide film.

14. The dye-sensitized solar cell of claim 1, further comprising a base layer disposed between the microlens elements and first substrate, the base layer being made of a hydrophilic electrically conductive material.

15. A dye-sensitized solar cell with internal microlens array, the dye-sensitized solar cell comprising:
an anodic electrode including an electrically conductive first substrate and a porous nano-structured active metal oxide layer supported thereon, the first substrate being positionable to receive incident light from a light source;
a cathodic counter-electrode including an electrically conductive second substrate spaced apart from the first substrate;
a sensitizer dye adsorbed on the nano-structured metal oxide layer;
an electrolyte contacting the nano-structured metal oxide layer; and
a microlens array disposed between the first substrate and the porous metal oxide layer, wherein the microlens array comprises a plurality of microlens elements having a configuration selected from the group consisting of convex-shaped microlens elements and concave shaped microlens elements, the microlens elements being arranged in a monolayer.

16. The dye-sensitized solar cell of claim 15, wherein the microlens elements have a height ranging from about and including 0.5 μm to about and including 1 μm.

17. The dye-sensitized solar cell of claim 1, wherein the microlens elements are convex microspheres or concave depressions.

18. A method for forming an anodic electrode for a dye-sensitized solar cell, the method comprising:
providing a substrate coated with a conductive transparent conductive oxide;
forming on the substrate a monolayer of microlens elements having a configuration selected from the group consisting of convex-shaped microlens elements and concave shaped microlens elements; and
forming a porous nano-structured metal oxide layer on the monolayer;
wherein the microlens elements are operable to transmit light.

19. The method of claim 18, wherein the step of forming a monolayer comprises depositing a 2-dimensional array of microspheres on the substrate.

20. The method of claim 19, wherein the step of depositing the microspheres includes using a convective deposition process.

21. The method of claim 19, further comprising steps of removing the microspheres from the substrate and forming concave depressions in an underfill layer disposed between the nano-structured metal oxide layer and substrate.

22. The method of claim 21, wherein the microspheres are polystyrene.

23. The method of claim 19, wherein the microspheres are made of light transmissible silica.

24. The method of claim 18, further comprising a step of adding an underfill layer comprised of a metal oxide material between the nano-structured metal oxide layer and microlens elements.

25. The method of claim 22, further comprising a step of heating the underfill layer to crystallize the metal oxide material.
